(19) United States
(12) Patent Application Publication
(10) Pub. No.: US 2018/0242687 A1
(43) Pub. Date: Aug. 30, 2018

(54) Sandal with Cushioning and Contoured Support

(71) Applicant: Tetrad Technologies, LLC, Waco, TX (US)

(72) Inventors: David Bradley Granger, Lorena, TX (US); Jacob Martinez, Temple, TX (US)

(73) Assignee: Tetrad Technologies, LLC, Waco, TX (US)

(21) Appl. No.: 15/758,141

(22) PCT Filed: Sep. 15, 2016
(86) PCT No.: PCT/US2016/051925

§ 371 Date: Mar. 7, 2018

Related U.S. Application Data
(60) Provisional application No. 62/233,083, filed on Sep. 25, 2015.

(51) Int. Cl. A43B 13/18; A43B 3/12; A43B 7/14

(52) U.S. Cl. CPC A43B 13/187; A43B 3/128; A43B 7/142; B29D 35/14; A43B 7/144; A43B 7/1445; A43B 7/143

(57) ABSTRACT

The present invention is a contoured and cushioned sandal (100) with the following features: (1) base bottom (ground contact) surface layer (137) supports the placement of a forefoot cushion (110) in the forefoot area having rolling ridges (112) (with gaps 13), a stability arch compression pad (127), a lateral metatarsal pad (115), a lateral heel pad (117), a medial heel pad (124) (separated by a gap 156), and a metatarsal dome (135); (2) a bifurcated longitudinal middle support layers (122 and 140); (3) a top (foot contact) surface with a raised arch (170), a raised metatarsal dome (167), a raised heel dome (168), cushioned foot areas (165), (175) (172), and a raised outer border (187); and, (4) cushioned straps (147) and toe strap 148 to secure the sandal to a user's foot.

### CROSS REFERENCE TO RELATED APPLICATIONS

This application claims the benefit of U.S. Provisional Patent Application Ser. No. 62/233,083 filed Sep. 25, 2015.

### STATEMENT REGARDING FEDERALLY SPONSORED RESEARCH OR DEVELOPMENT

Not applicable

### TECHNICAL FIELD

The present invention relates in general to an improved sandal and more particularly to a sandal providing improved cushioning and support to the foot of a wearer.

### BACKGROUND OF THE INVENTION

The human foot is a very complex biological mechanism. The load on the foot at heel strike is typically about one and a half times a person's body weight when a person walks. When running or carrying extra weight, such as a backpack, loads on the foot can exceed three times the body weight. The many bones, muscles, ligaments, and tendons of the foot function to absorb and dissipate the forces of impact, carry the weight of the body and other loads, and provide threes for propulsion. Properly designed shoe and sandals can assist the toot in performing these functions and protect the foot from injury.

Soles and sandals may be custom made to address the specific needs of an individual. They may be made based on casts of the end user's foot or may be made of a thermoplastic material that is molded to the contours of the end user's foot. Like most custom made items, custom shoes and sandals tend to be expensive because of the low volume and extensive time needed to make and fit them properly. As such, it is not practical to make such custom made shoes and sandals for the general public. Certain shoes and sandals emphasizes control.

Typically, such shoes and sandals are made to be relatively stiff and rigid so as to control the bending and twisting of the foot by limiting foot motion. The rigid structure is good at controlling motion, but is not very forgiving. As a result, when motion of the foot reaches a limit imposed by the rigid structure, the load on the foot tends to change abruptly and increases the load on the structures of the foot. Because biological tissues such as tendons and ligaments are sensitive to the rate at which they are loaded, the abrupt change in load causes injury or damage to the foot, ankle or leg

There is fine balance between comfort and support in most shoes and sandals. While comfort is important for proper shoes and sandals, the support provided to different parts of the feet by a shoe and sandal is a very important feature. Shoes that are very comfortable may not provide enough support to the feet. And, similarly, shoes that are very supportive of the feet may not provide enough comfort.

Typical prior art arch support for a foot is stiff, static, and uncomfortable. A stiff and static arch support cannot satisfy everyone's needs. For a customized shoe construction, a properly shaped (but overly stiff) arch support cannot be fully supportive as the shape of the arch changes with normal walking movement. Prior art shoes with additional, albeit minimal, comfort to the arch support is provided by having a soft layer above the stiff arch support. Therefore, there is a need for a shoe construction that provide a proper balance of both comfort and support, in particular at the arch support.

In articles of footwear having soft and yielding cushioning material, these materials are utilized both for cushioning purposes as well as supporting purposes. These cushioning materials tend to migrate or spread laterally under pressure thereby materially reducing its effectiveness. Articles of this type heretofore made also failed in providing wieldable yet sufficient support to the metatarsal and longitudinal arches of the foot while at the same time cushioning the plantar surface of the foot, and retaining the effectiveness of the cushioning and supporting action throughout the life of the article.

In view of the foregoing it would be desirable to provide a shoe and sandal that provides both cushioning and control and is practical for use by the general public while worn by the user. There is a need for sandals to be easier to construct and made of materials that: (1) provide increased ankle and foot stability, (2) cushion the heel and forefoot during push-offs and landings, (3) custom-contour to the inside shape of all types of shoes, (4) are extremely light-weight, (5) provide enhanced cushioning capabilities and (6) have essentially zero movement or sliding while worn by the user.

Patents have been issued for shoes and footwear including U.S. Pat. Nos. 2,404,083; 2,600,864; 2,611,978; 2,732,634; 2,979,835; 3,063,458; 3,258,957; 3,595,244; 3,861,398; 4,908,964; 6,713,006; US Publ. No. 2012/0184889; WO 2015/100330A1. Various patents have been received for shoe insoles having a support cushion and multiple pods located thereon. These patents include U.S. Pat. Nos. 7,484,319; 7,665,169; 7,908,768; and, 8,250,784. These prior art patents, however, do not address the problems of enhanced cushioning and stability, possible movement of the sandal insole during shoe operation, or establishing enhanced cushioning characteristics to address running and walking usages.

### SUMMARY OF THE INVENTION

The present invention provides a shoe construction that achieves an appropriate balance between comfort and support. The shoe construction of the present invention provides an improved arch support that is customized and self-adjusted to provide maximum comfort and support, even when the shape of the arch changes during movement. With the foregoing in mind, it is an important object of the instant invention to provide an article of footwear of the type of a sandal which presents continuously a soft and comfortable feel to the foot of the user, which cushions the plantar surface of the foot and effectively supports the metatarsal and longitudinal arches of the foot while presenting only a soft and yielding pressure against the foot.

As shown in FIGS. 1-8, the present invention is a contoured and cushioned sandal 100 with the following features: (1) base bottom (ground contact) surface layer 137 supports the placement of a forefoot cushion 110 in the forefoot area having rolling ridges 112 (with gaps 113), a stability arch compression pad 127, a lateral metatarsal pad 115, a lateral heel pad 117, a medial heel pad 124 (separated by a gap 156), and a metatarsal dome 135, (2) a bifurcated longitudinal middle support layers (122 and 140), (3) a top (foot contact) surface with a raised arch 170, a raised metatarsal dome 167, a raised heel dome 168, cushioned foot areas 165 and 172, and a raised outer border 175; and, (4) cushioned straps 147 and toe strap 148 to secure the sandal to a user's foot. In an alternative embodiment shown in FIGS. 9-12 the rolling ridges 112 in the forefoot area 110 can be replaced with a flat cushion pad 210.

This invention relates to improvements in a foot cushioning and supporting sandal, and more particularly to an article of footwear of the type of a sandal, an open-toed open-heeled type of shoe, and equivalent structures wherein the upper of the article of footwear is strap-like in character leaving portions of the foot or hosiery of the wearer exposed, although the invention might be utilized for other purposes, as will be apparent to one skilled in the art. The above, and other objects and advantages of the present invention are provided by a sandal that provides improved motion control, support and cushioning.

Overall, the above features appear to be novel characteristics for this sandal, and seem to be patentably distinct from the other shoes or sandals. The method of construction of the present sandal is also a unique and novel feature of the present invention. In accordance with principles of the present invention, a cushioning core or base is combined with a relatively stiff support cushion and a number of other pads to form a sandal that provides greater cushioning, stability, and control than was conventionally known in the state of the art. The pads can have a different firmness than the base or the support cushion. The pads and support cushion assist with prevention of supination, and the supplemental heel pad assists with the prevention of pronation. The current invention is a sandal that provides a balanced approach to improving longitudinal arch support, prevention of pronation and prevention of supination by incorporation of the combination of the above elements.

The characteristics of the components, their size and shape, and their position are selected to provide a desired blend of improved cushioning and control, and more specifically to achieve a desired biomechanical function. The size and compression characteristics of the pads can be adjusted to address issues of over/under pronation, over/under supination, and other problems related to foot motion, including altering the size, shape, and material properties of the pads.

The firmness of the pads and support cushion can be adjusted to address issues of over/under pronation, over/under supination, and other problems related to foot motion by altering the size, shape, and material properties of the pads. The present invention accomplishes the goals to: (1) improve ankle and foot stability, (2) cushion the heel and forefoot during push-offs and landings, (3) help prevent over pronation and over supination conditions, and (4) provide enhanced cushioning features to the heel, midfoot, arch and forefoot areas. In a preferred embodiment of the present invention, the components of the sandal are permanently affixed to each other to create a sandal designed for an intended type or category of activity. Many different sandal designs can be made to address a broad range of different activities.

### BRIEF DESCRIPTION OF THE DRAWINGS

Because of the complexity of the shapes involved with the present invention, the inventor will describe the invention using descriptive drawings and text, which will describe the device and how it functions.

FIG. 1 is a bottom perspective view of the sandal in the present invention;

FIG. 2 is a bottom view of the sandal in the present invention;

FIG. 3 is a top view of the sandal in the present invention;

FIG. 4 is a medial side view f the sandal in the present invention;

FIG. 5 is a lateral side view of the sandal in the present invention;

FIG. 6 is a front view of the sandal in the present invention;

FIG. 7 is a back view of the sandal in the present invention;

FIG. 8 is a top perspective view of the sandal in the present invention;

FIG. 9 is a bottom perspective view of an alternate embodiment of the sandal in tine present invention;

FIG. 10 is a bottom view of the sandal in the present invention;

FIG. 11 is a medial side view of the sandal in the present invention; and,

FIG. 12 is a lateral side view of the sandal in the present invention.

### DETAILED DESCRIPTION

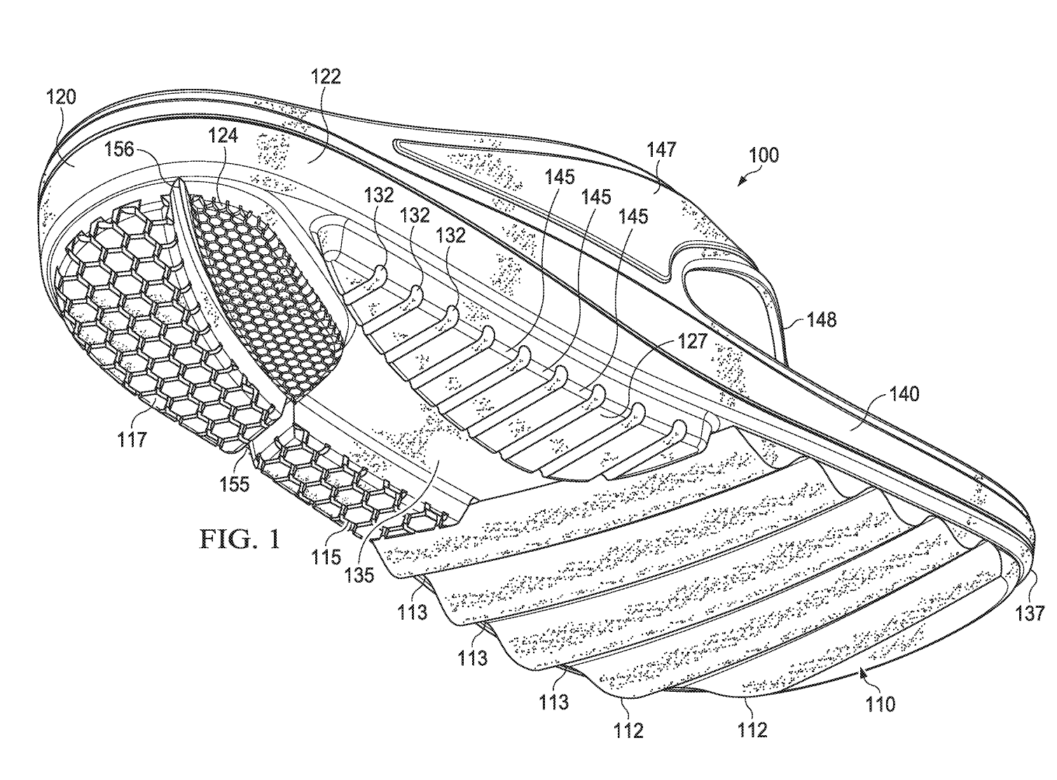

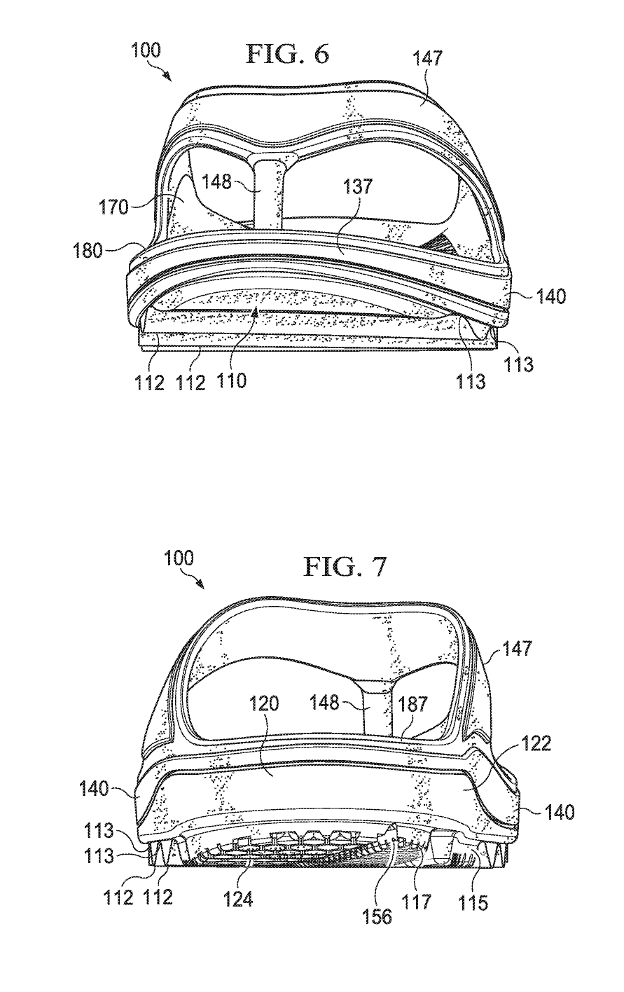

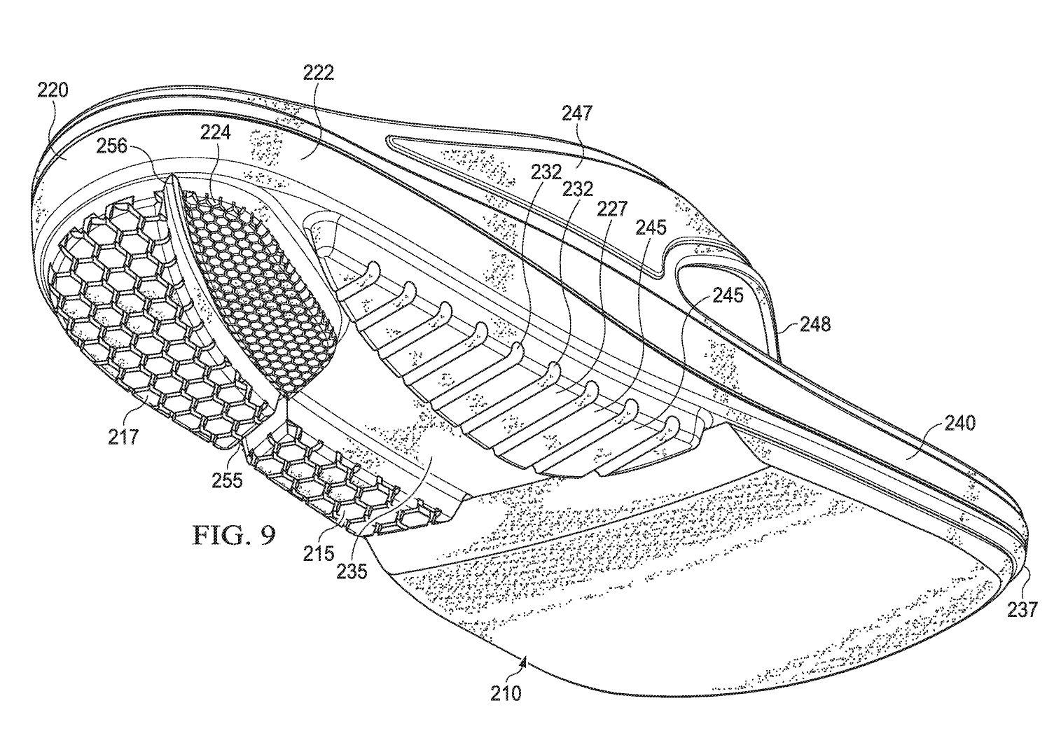

As shown in FIGS. 1-8, the present invention is a contoured and cushioned sandal 100 with the following features: (1) base bottom (ground contact) surface layer 137 supports the placement of a forefoot cushion 110 in the forefoot area having rolling ridges 112 (with gaps 113), a stability arch compression pad 127, a lateral metatarsal pad 115, a lateral heel pad 117, a medial heel pad 124 (separated by a gap 156), and a metatarsal dome 135, (2) a bifurcated longitudinal middle support layers (122 and 140), (3) a top (foot contact) surface with a raised arch 170, a raised metatarsal dome 167, a raised heel dome 168, cushioned foot areas 165, 175 172, and a raised outer border 187; and, (1) cushioned straps 147 and toe strap 148 to secure the sandal to a user's foot. Surrounding the a top (foot contact) surface of the sandal 100 is a raised outer border 187 that improves stability and support of the user's foot, and prevents slippage of the foot in the sandal 100, and an internal raised slope 175 is positioned between the top surface contact of the sandal and the raised edge 187. In an alternative embodiment shown in FIGS. 9-12 the rolling ridges 112 in the forefoot area 110 can be replaced with a flat cushion pad 210.

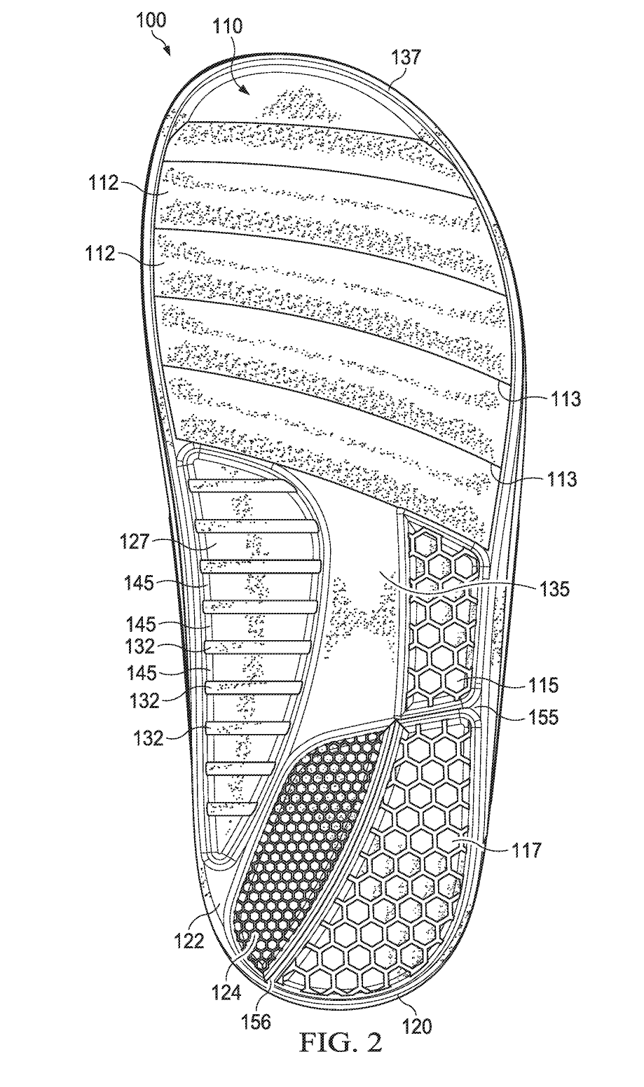

As shown in FIGS. 1-2, the base bottom surface is defined on the bottom surface of the sandal 100 and is generally foot-shaped extending longitudinally from the from the toe end 180 to the heel end 120 and from the medial side to the lateral side of the sandal 100. The base bottom surface may have indentations dimensioned to receive pads or alternatively may have openings through the base bottom surface to receive pads that would secure to the middle layer. The base may be molded of ethylene vinyl acetate (EVA), pre-blown EVA, polyurethane (PU), or thermoplastic rubber (TPR) or other suitable material. Specifically, a base made of molded of lightweight materials such as low density polyurethane memory foam, ethylene glycol polyurethane, ethylene vinyl acetate (EVA), pre-blown EVA, polyurethane (PU), or thermoplastic rubber (TPR) or other suitable material with hardness of the molded base material can range from less than 10 Asker ±3 to greater than 30 Asker ±3.

The base bottom layer 137 supports the following functional features: a forefoot pad 110 having rolling ridges 112 (with gaps 113) in the forefoot area, a stability arch compression pad 127, a lateral metatarsal pad 115, a lateral heel pad 117, a medial heel pad 124 (separated by a gap 156), and a metatarsal dome 135. As shown in FIGS. 1-2, the forefoot cushioning pad 110 has a ridged area with deep rolling ridges 112 oriented in a direction transverse to the longitudinal axis of the sandal (lengthwise), which means the ridges 112 and gaps 113 in the forefoot pad 110 generally extending laterally across the sandal forefoot from the medial to the lateral side and are located from the toe end 180 to the midfoot area adjacent the medial arch / lateral midfoot area. The raised portions of the ridges 112 provide traction in the toe area, and the depressed portions 113 of the ridged areas 112 provide for improved flexing in the toe area 180. In an alternate embodiment, the forefoot cushioning pad can have an integrally formed honeycombed pattern, or in yet another embodiment shown in FIGS. 9-11, the forefoot cushioning pad 210 can have a flat surface.

The forefoot cushioning pad 110 may be integrally formed into the base layer 137, integrally formed in the middle support layer 122, protruding through an opening in the base layer 137 or may be a separately formed pad which is secured to the base bottom layer 137 or secured to the middle support layer 122 through an opening in the base bottom layer 137. The forefoot cushioning pad 110 may be molded of ethylene vinyl acetate (EVA), pre-blown EVA, polyurethane (PU), or thermoplastic rubber (TPR) or other suitable material. More particularly, the forefoot cushioning pad 110 can be molded of lightweight materials such as low density polyurethane memory foam, ethylene glycol polyurethane, ethylene vinyl acetate (EVA), pre-blown EVA, polyurethane (PU), or thermoplastic rubber (TPR) or other suitable material with hardness of the molded base material can range from less than 10 Asker ±3 to greater than 30 Asker ±3. The forefoot cushioning pad 110 may have a thickness of approximately 4.0 mm±0.3 mm, or alternatively, integrally formed in the material of the base bottom layer 137 of the sandal 100.

The stability arch compression pad 127 is located in the medial arch area of the bottom layer 137, and it has grooves 132 oriented in a direction transverse to the longitudinal length (toe to heel axis) of the sandal. Between the grooves 132 are raised flat compression pads 145 that generally extend laterally from the medial side of the arch area to the midfoot area. The grooves 132 and flat compression pads 145 occupy the stability arch compression pad 127, but these features all extend transverse to the longitudinal lengthwise (toe to heel) axis of the sandal from the medial arch area to the metatarsal area of the base layer 137. The grooves and compression pads provide greater traction and flexibility in the medial arch area of the sandal.

The arch support compression pad 127 may be integrally formed in the base layer 137, integrally formed in the middle support layer 122 protruding through an opening in the base layer 137 or may be a separately formed pad which is secured to the base bottom layer 137 or secured to the middle layer 122 through an opening in the base bottom surface. The arch support compression pad 127 may be molded of ethylene vinyl acetate (EVA), pre-blown EVA, polyurethane (PU), or thermoplastic rubber (TPR) or other suitable material. The arch support compression pad 127 may be molded of ethylene vinyl acetate (EVA), pre-blown EVA, polyurethane (PU), or thermoplastic rubber (TPR) or other suitable material. More particularly, the forefoot cushioning pad 110 can be molded of lightweight materials such as low density polyurethane memory foam, ethylene glycol polyurethane, ethylene vinyl acetate (EVA), pre-blown EVA, polyurethane (PU), or thermoplastic rubber (TPR) or other suitable material with hardness of the molded base material can range from less than 10 Asker ±3 to greater than 30 Asker ±3. The arch support compression pad 127 may have a thickness of approximately 3.0 mm±0.3 min, or alternatively, integrally formed in the material of the base bottom layer 137 of the sandal 100.

The lateral metatarsal midfoot cushioning pad 115 is a trapezoidal shaped area extending generally from the distal edge of the heel area 120 to the proximal edge of the forefoot area on the lateral side of the sandal bottom layer 137 and encompassing the area approximately under a portion of the 4^{th} and 5^{th} metatarsal bones and a portion of the cuboid bone. The lateral metatarsal midfoot cushioning pad 115 provides cushioning and support for the lateral midfoot area. The lateral metatarsal cushioning pad 115 preferably has an integrally formed honeycombed cushioning pattern, but can also possess an integrally formed raised column pattern, and it may have a thickness of approximately 3.0 mm±0.3 mm, or alternatively, integrally formed in the material of the base bottom layer 137 of the sandal 100.

The lateral midfoot cushioning pad 115 may be integrally formed in the base layer 137, integrally formed in the middle support layer 122 protruding through an opening in the base layer 137 or may be a separately formed pad which is secured to the base bottom layer 137 or secured to the middle layer 1 22 through an opening in the base bottom surface. The lateral midfoot cushioning area may be molded of ethylene vinyl acetate (EVA), pre-blown EVA, polyurethane (PU), or thermoplastic rubber (TPR) or other suitable material. More specifically, the lateral midfoot cushioning pad 115 may be molded of ethylene vinyl acetate (EVA), pre-blown EVA, polyurethane (PU), or thermoplastic rubber (TPR) or other suitable material. More particularly, the forefoot cushioning pad 110 can be molded of lightweight materials such as low density polyurethane memory foam, ethylene glycol polyurethane, ethylene vinyl acetate (EVA), pre-blown EVA, polyurethane (PU), or thermoplastic rubber (TPR) or other suitable material with hardness of the molded base material can range from less than 10 Asker ±3 to greater than 30 Asker ±3.

The lateral heel cushioning pad 117 and medial heel cushioning pad 124 are shown in FIGS. 1-2 in the heel area 120 of the sandal 100. The lateral heel cushioning pad 117 extends generally from the heel (calcaneal bone) area 180 forward to a portion of the cuboid bone on the lateral side of the sandal bottom 137 adjacent the lateral midfoot cushioning pad 115 and extends medially from the lateral side of the heel area to approximately the central portion of the heel area 180. The lateral heel cushioning area provides flexible cushioning and support under the lateral side of the heel (calcaneal) bone. The medial heel cushioning pad 124 extends generally from the central portion of the heel area 180 toward the medial side of the heel area and extends from the proximal heel area forward toward the cuboid bone on the medial side of the sandal bottom layer 137. The medial heel cushioning pad 124 provides flexible cushioning and support under the medial side of the heel (calcaneal) and talus bones.

The lateral cushioning pad 117 and medial heel cushioning pad 124 preferably have an integrally formed honeycombed pattern, and each of these pads may have a thickness of approximately 3.0 mm±0.3 mm, or alternatively, integrally formed in the material of the base bottom layer 137 of the sandal 100. The honeycomb pattern will preferably be of different diameters and/or depths on the lateral and medial sides of the heel area to provide variable levels of support under the heel. The hardness of the two pads may also vary to provide softer or firmer cushioning individually to the two sides of the heel. Alternatively, the lateral cushioning pad 117 and medial heel cushioning pad 124 may have an integrally formed raised column pattern on the lateral and medial sides. In another embodiment, one of the heel cushioning pads 117 or 124 may have an integrally formed honeycomb cushioning pattern and the other heel cushioning pad 124 or 117 may have an integrally formed raised column pattern.

The lateral cushioning pad 117 and medial heel cushioning pad 124 may be integrally formed in the base layer 137, integrally formed in the middle support layer 120 protruding through openings in the base layer 137 or may be separately formed pads which are secured to the base bottom layer 137 or secured to the middle support layer 120 through openings in the base bottom layer 137. The lateral cushioning pad 117 and medial heel cushioning pad 124 may be molded of ethylene vinyl acetate (EVA), pre-blown EVA, polyurethane (PU), or thermoplastic rubber (1PR) or other suitable material. The lateral cushioning pad 117 and medial heel cushioning pad 124 may be molded of ethylene vinyl acetate (EVA), pre-blown EVA, polyurethane (PU), or thermoplastic rubber (TPR) or other suitable material. More particularly, the forefoot cushioning pad 110 can be molded of lightweight materials such as low density polyurethane memory foam, ethylene glycol polyurethane, ethylene vinyl acetate (EVA), pre-blown EVA, polyurethane (PU), or thermoplastic rubber (TPR) or other suitable material with hardness of the molded base material can range from less than 10 Asker ±3 to greater than 30 Asker ±3.

The central midfoot metatarsal dome 135 is a concave area in the center of the sandal 100 base bottom surface 137 adjacent the medial arch pad 127, the forefoot pad 110, lateral midfoot pad 115, and the medial heel pad 124. The dome, or concave indentation, provides an improved flexure zone for the cushioning and support components of the medial arch area, lateral midfoot area, forefoot area and heel area. The central midfoot metatarsal indentation is integrally formed in the base bottom surface 137 of the sandal 100 which may be molded of ethylene vinyl acetate (EVA), pre-blown EVA, polyurethane (PU), or thermoplastic rubber (TPR) or other suitable material.

Gaps and separations 155 and 156 between the base components on the base bottom surface 137 also provide improved flexure zones for the cushioning and support components of the medial arch area, lateral midfoot area, forefoot area and heel area. Separation gap 155 is positioned between the lateral midfoot pad 115 and the lateral heel pad 117, and separation gap 156 is located between the lateral heel pad 117 and the medial heel pad 124.

The middle support layer extends the length and width of the sandal forming an intermediate layer to provide shape to the sandal footbed and to provide cushioning and support to the user's foot. The middle support layer is contoured to provide an area that curves downward forming an area to position the ball of the foot in the forefoot area and curving downward to form a heel cup to position the heel in the heel area. The middle support layer is also contoured to provide a raised area that curves upward to support the medial arch area.

The middle support layer 122 is secured to the base bottom layer 137, and layer 122 may have cushioning and support components integrally formed in the layer which protrude downward through the base bottom surface forming a portion of the ground contact surface or protruding upward through the top surface forming a portion of the foot contact surface. The middle support layer 122 may be molded of ethylene vinyl acetate (EVA), pre-blown EVA, polyurethane (PU), or thermoplastic rubber (TPR) or other suitable material. The middle support layer 122 has variable depth thickness of 2.0 mm±0.5 mm on the thin end at the toe area 180 to a thicker depth thickness 5.0 mm+2.5 mm on the thick end of the heel area 120.

The upper support layer 140 is secured middle support layer 122, and layer 140 is positioned under the top layer components, which may integrally formed in the layer which protrude upward through the layer 140 forming a portion of the top contact surface. The upper support layer 140 may be molded of ethylene vinyl acetate (EVA), pre-blown EVA, polyurethane (PU), or thermoplastic rubber (TPR) or other suitable material. The middle support layer 140 has variable depth thickness of 2.0 mm±0.5 mm on the thin end at the heel area 120 to a thicker depth thickness 5.0 mm±2.5 mm on the thick end of the toe area 180.

Both the middle support layer 122 and the upper support layer 140 are preferably made of foam or other material having suitable cushioning properties, including a fabric layer. Base layer 137 underlies the middle support layer 122, and base layer 137 comprises an Ethylene vinyl acetate (“EVA”) foam, which is a copolymer of ethylene and vinyl acetate, a Thermoplastic Rubber (“TPR”)/EVA mix, or a blown EVA material. A preferred blown EVA, EVA or TPR/EVA mix has a durometer (hardness) of about Asker C 45-50. The base layer 137 may also be formed from a gel material or made of polyurethane polyester glycol with a hardness of 30 Asker ±3, or alternatively, can be made of a durable nylon fabric. Alternatively, the base layer 137 may be molded of ethylene vinyl acetate (EVA), pre-blown EVA, polyurethane (PU), or thermoplastic rubber (TPR) or other suitable material, or it may be molded of ethylene vinyl acetate (EVA), pre-blown EVA, polyurethane (PU), or thermoplastic rubber (TPR) or other suitable material. More particularly, the forefoot cushioning pad 110 can be molded of lightweight materials such as low density polyurethane memory foam, ethylene glycol polyurethane, ethylene vinyl acetate (EVA), pre-blown EVA, polyurethane (PU), or thermoplastic rubber (TPR) or other suitable material with hardness of the molded base material can range from less than 10 Asker ±3 to greater than 30 Asker ±3.

Base layer 137 extends from heel area 120 to toe area 180, has a depth thickness of 3.0 mm±1.5 mm, and is preferably made of foam or other material having suitable cushioning properties, including a fabric layer. Base layer 137 underlies the middle support layer 122, and base layer 137 comprises an Ethylene vinyl acetate (“EVA”) foam, which is a copolymer of ethylene and vinyl acetate, a Thermoplastic Rubber (“TPR”)/EVA mix, or a blown EVA material. A preferred blown EVA, EVA or TPR/EVA mix has a durometer (hardness) of about Asker C 45-50. The base layer 137 may also be formed from a gel material or made of polyurethane polyester glycol with a hardness of 30 Asker ±3, or alternatively, can be made of a durable nylon fabric. Alternatively, the base layer 137 may be molded of ethylene vinyl acetate (EVA), pre-blown EVA, polyurethane (PU), or thermoplastic rubber (TPR) or other suitable material, or it may be molded of ethylene vinyl acetate (EVA), pre-blown EVA, polyurethane (PU), or thermoplastic rubber (TPR) or other suitable material. More particularly, the forefoot cushioning pad 110 can be molded of lightweight materials such as low density polyurethane memory foam, ethylene glycol polyurethane, ethylene vinyl acetate (EVA), pre-blown EVA, polyurethane (PU), or thermoplastic rubber (TPR) or other suitable material with hardness of the molded base material can range from less than 10 Asker ±3 to greater than 30 Asker ±3.

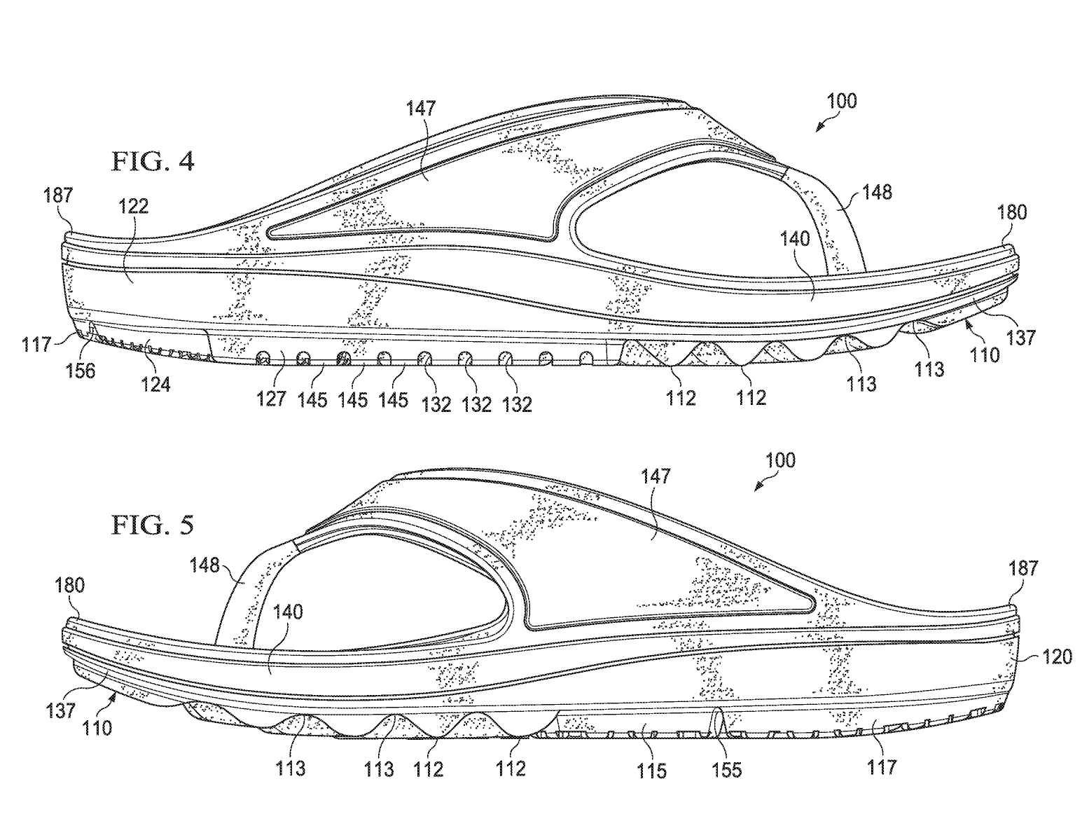

As shown in FIGS. 4-7, the sides, front and back of the sandal 100 are shown. In these figures, the features of the present invention include: (1) base bottom (ground contact) surface layer 137 supports the placement of a forefoot cushion 110 in the forefoot area having rolling ridges 112 (with gaps 113), a stability arch compression pad 127, a lateral metatarsal pad 115, a lateral heel pad 117, a medial heel pad 124 (separated by a gap 156), and a metatarsal dome 135 (not seen in these figures), (2) a bifurcated longitudinal middle support layers (122 and 140), (3) a top (foot contact) surface with a raised arch 170, a raised metatarsal dome 167, a raised heel dome 168, cushioned foot areas 165 and 172, and a raised outer border 187; and, (4) cushioned straps 147 and toe strap 148 to secure the sandal to a user's foot. Surrounding the a top (foot contact) surface of the sandal 100 is a raised outer border 187 that improves stability and support of the user's foot, and prevents slippage of the foot in the sandal 100, and an internal raised slope 175 is positioned between the top surface contact of the sandal and the raised edge 187.

In FIGS. 4-7, the base bottom surface is defined on the bottom surface of the sandal 100 and is generally foot-shaped extending longitudinally from the from the toe end 180 to the heel end 120 and from the medial side to the lateral side of the sandal 100. The base bottom surface may have indentations dimensioned to receive pads or alternatively may have openings through the base bottom surface to receive pads that would secure to the middle layer.

The base bottom layer 137 supports the following functional features: a forefoot pad 110 having rolling ridges 112 (with gaps 113) in the forefoot area, a stability arch compression pad 127, a lateral metatarsal pad 115, a lateral heel pad 117, a medial heel pad 124 (separated by a gap 156), and a metatarsal dome 135. As shown in FIGS. 1-2, the forefoot cushioning pad 110 has a ridged area with deep rolling ridges 112 oriented in a direction transverse to the longitudinal axis of the sandal (lengthwise), which means the ridges 112 and gaps 113 in the forefoot pad 110 generally extending laterally across the sandal forefoot from the medial to the lateral side and are located from the toe end 180 to the midfoot area adjacent the medial arch/lateral midfoot area. The raised portions of the ridges 112 provide traction in the toe area, and the depressed portions 113 of the ridged areas 112 provide for improved flexing in the toe area 180.

The stability arch compression pad 127 is located in the medial arch area of the bottom layer 137, and it has grooves 132 oriented in a direction transverse to the longitudinal length (toe to heel axis) of the sandal. Between the grooves 132 are raised flat compression pads 145 that generally extend laterally from the medial side of the arch area to the midfoot area. The grooves 132 and flat compression pads 145 occupy the stability arch compression pad 127, but these features all extend transverse to the longitudinal lengthwise (toe to heel) axis of the sandal from the medial arch area to the metatarsal area of the base layer 137.

The lateral metatarsal midfoot cushioning pad 115 is a trapezoidal shaped area extending generally from the distal edge of the heel area 120 to the proximal edge of the forefoot area on the lateral side of the sandal bottom layer 137 and encompassing the area approximately under a portion of the 4^{th} and 5^{th} metatarsal bones and a portion of the cuboid bone.

The lateral heel cushioning pad 117 and medial heel cushioning pad 124 are shown in FIGS. 1-2 in the heel area 120 of the sandal 100. The lateral heel cushioning pad 117 extends generally from the heel (calcaneal bone) area 180 forward to a portion of the cuboid bone on the lateral side of the sandal bottom 137 adjacent the lateral midfoot cushioning pad 115 and extends medially from the lateral side of the heel area to approximately the central portion of the heel area 180.

Gaps and separations 155 and 156 between the base components on the base bottom surface 137 also provide improved flexure zones for the cushioning and support components of the medial arch area, lateral midfoot area, forefoot area and heel area. Separation gap 155 is positioned between the lateral midfoot pad 115 and the lateral heel pad 117, and separation gap 156 is located between the lateral heel pad 117 and the medial heel pad 124.

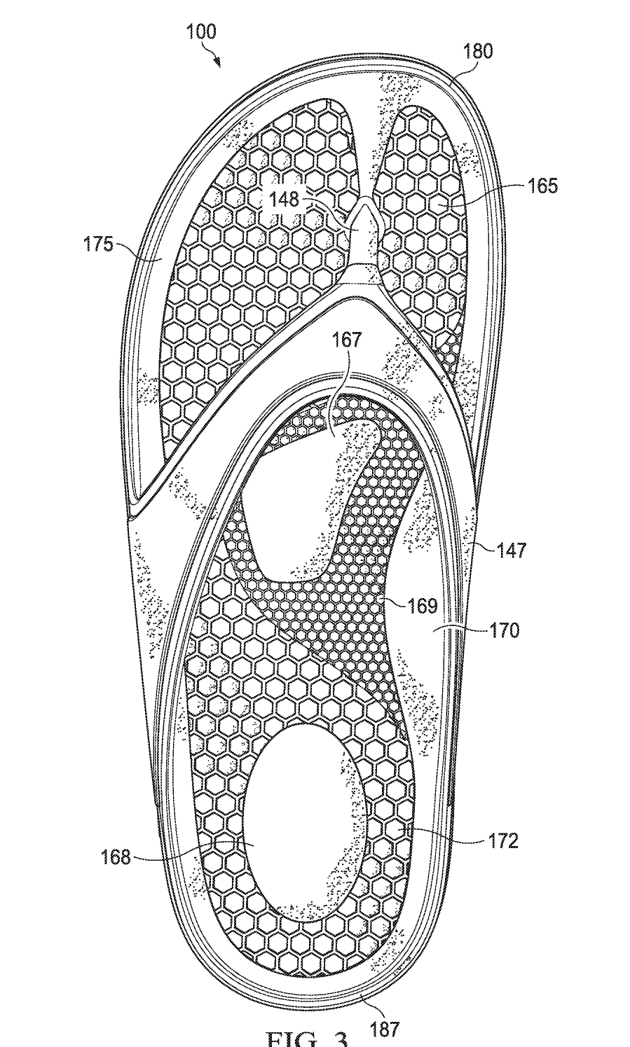

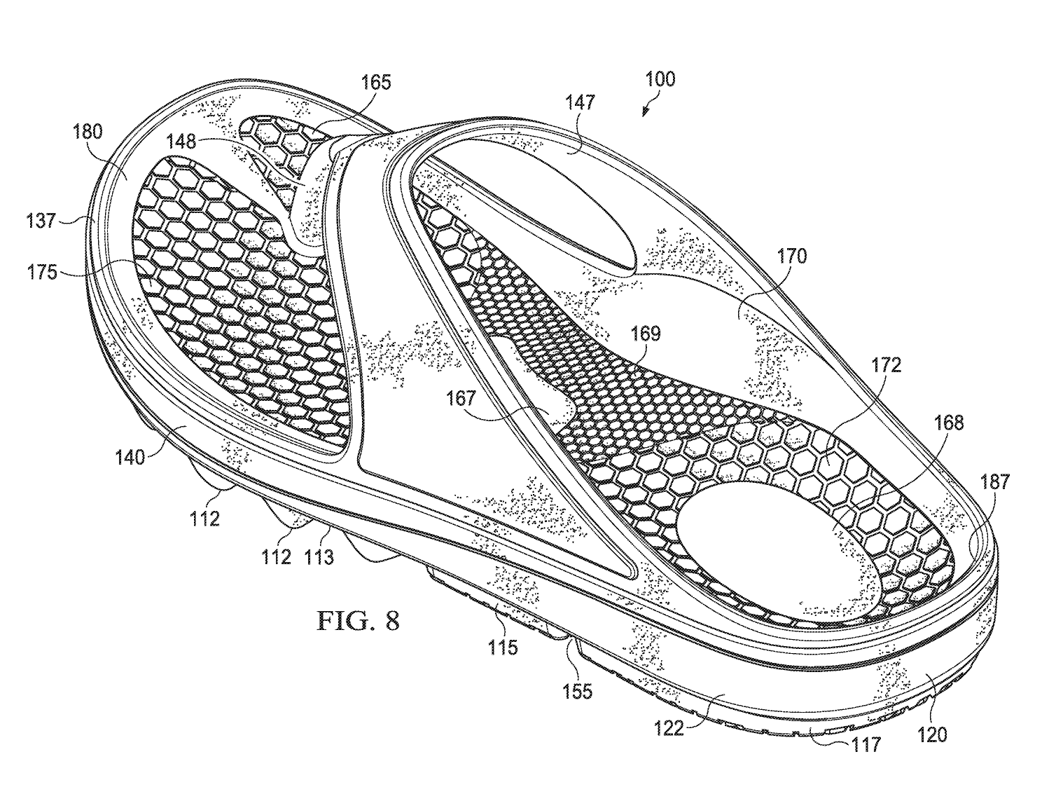

As shown in FIGS. 3 and 8, the top surface of the sandal 100 is shown. In these figures, the features of the present invention include: (1) base bottom (ground contact) surface layer 137 is partially shown and supports the placement of a forefoot cushion 110 in the forefoot area having rolling ridges 112 (with gaps 113), a stability arch compression pad 127, a lateral metatarsal pad 115, a lateral heel pad 117, a medial heel pad 124 (separated by a gap 156), and a metatarsal dome 135 (not seen in these figures), (2) a bifurcated longitudinal middle support layers (122 and 140), (3) a top (foot contact) surface with a raised arch 170, a raised metatarsal dome 167, a raised heel dome 168, cushioned foot areas 165, 175, 172, and a raised outer border 187; and, (4) cushioned straps 147 and toe strap 148 to secure the sandal to a user's foot. The top surface extends longitudinally from the toe end to the heel of the sandal and laterally from the medial side to the lateral side of the sandal's foot contact surface. The top surface has an integally formed honeycombed cushioning pattern that contacts the user's foot in the forefoot area, along the lateral midfoot area and in the heel area to provide cushioning under the ball and heel of a user's foot.

The top surface encompasses the following cushioning and support functional areas: a raised medial arch 170, a metatarsal cushion dome 167, a heel cushion dome 168, and top surface cushioning layers 165 and 172 having a large diameter honeycomb top surface. Surrounding the a top (foot contact) surface of the sandal 100 is a raised outer border 187 that improves stability and support of the user's foot, and prevents slippage of the foot in the sandal 100, and an internal raised slope 175 is positioned between the top surface contact of the sandal and the raised edge 187. The top (foot contact) surface of the sandal 100 may also have a top sheet covering that extends across the top surface from the heel end 120 to toe end 180, and creates a top surface of the sandal 100. The top sheet can be made of polyester or jadeite covering the entire foot contact surface of the sandal, and is treated with an antimicrobial agent. Top sheet is typically made of a non-woven fabric layer with a low coefficient of friction so as to minimize the possibility of blisters, or preferably, top sheet is made of a cooling fabric which contains a special low temperature jade obtained from a natural source. The top sheet may also be treated with an antimicrobial agent to control microbial growth on the sandal surface.

The raised medial arch 170 may be integrally formed in the top surface of the sandal, integrally formed in the upper support layer 140 protruding through an opening in the top surface to form part of the foot contact surface or may be a separately formed pad which is secured to the top surface or secured to the upper support layer 140 through an opening in the top surface. The medial arch cushioning area may be molded of ethylene vinyl acetate (EVA), pre-blown EVA, polyurethane (PU), or thermoplastic rubber (TPR) or other suitable material. The raised medial arch 170 on the top surface may be formed of additional honeycomb patterned cushioning area extending from the medial arch area across the midfoot portion of the sandal surface to approximately the area adjacent the midline of the foot. The honeycombed pattern 169 in the medial arch cushioning area preferably has a smaller diameter than the honeycombed pattern on the other portions 175, 165 and 172 of the top surface to provide additional cushioning directly under the medial arch of the user's foot.

The metatarsal cushion dome 167 is a raised area in the center of the midfoot area on the top (foot contact) surface of the sandal 100 and is surrounded by the medial arch support area. The metatarsal cushion dome 167 provides support to the central portion of the metatarsal bones of the user's foot. The metatarsal dome 167 may be integrally formed in the top surface along with the medial arch cushioning area, integrally formed in the middle support layer protruding through the medial arch cushioning area, or may be a separately formed pad which is secured to the medial arch cushioning area or secured to the middle support layer through an opening in the medial arch cushioning area. The metatarsal cushion dome 167 may be molded of ethylene vinyl acetate (EVA), pre-blown EVA, polyurethane (PU), or thermoplastic rubber (TPR) or other suitable material.

The heel cushioning dome 168 area provides cushioning directly under the user's heel on the top (foot contact) surface of the sandal, and is generally dimensioned to sit under the heel (calcaneal) bone. The top heel cushioning dome 168 will preferably have a smooth, non-patterned surface. Alternatively, the top heel cushioning dome 168 may have a honeycombed cushioning pattern or a raised column cushioning pattern.

The top heel cushioning dome 168 may be integrally formed in the top surface in the heel area, integrally formed in the upper support layer 140 protruding through the heel area, or may be a separately formed pad which is secured to the top surface or secures to the middle support layer through an opening in the heel area. The top heel cushioning dome 168 may be molded of ethylene vinyl acetate (EVA), pre-blown EVA, polyurethane (PU), or thermoplastic rubber (TPR) or other suitable material.

Alternatively, the heel dome 168 and the metatarsal dome 167 are preferably formed of super soft low density polyurethane, but may be formed of polyurethane memory foam, ethylene glycol polyurethane, ethylene vinyl acetate (EVA), pre-blown EVA, polyurethane (PU), thermoplastic rubber (TPR) or other suitable material. Hardness of the heel dome 118A and the metatarsal dome 134 material can range from less than 10 Asker ±3 to greater than 30 Asker ±3.

The sandal has straps 147 and 148 secured to either the top surface, middle support layers 140, 122 or base bottom layer 137 of the sandal to hold the sandal on the user's foot. Preferably, the straps 147 and 148 are a thong type with a support point positioned at the base of the juncture between the great toe and the second toe with a strap going from the support point between the toes over the metatarsal area on the top of the foot and dividing into one strap that secures to the medial side of the sandal and one that secures to the lateral side of the sandal. Alternatively, the straps 147 and 148 may cross over the top part of foot to the medial and lateral sides of the sandal, but not be secured between the toes.

The straps 147 and 148 may vary in width as needed to provide both function and fashion. The straps 147 and 148 may be may molded of ethylene vinyl acetate (EVA), pre-blown EVA, polyurethane (PU), or thermoplastic rubber (TPR) in like manner to the sandal components, or may be formed of woven or non-woven materials, or combinations thereof, that provide the necessary support.

FIGS. 9-11 show an alternative embodiment of the sandal 100 where the rolling ridges 112 in the forefoot area 110 can be replaced with a flat cushion pad 210. The alternative embodiment of the invention 100 is a contoured and cushioned sandal 100 with the following features: (1) base bottom (ground contact) surface layer 237 supports the placement of a forefoot cushion 210 in the forefoot area having a flat surface, a stability arch compression pad 227, a lateral metatarsal pad 215, a lateral heel pad 217, a medial heel pad 224 (separated by a gap 256), and a metatarsal dome 235, (2) a bifurcated longitudinal middle support layers (222 and 240), (3) a top (foot contact) surface (same as FIGS. 1-8) with a raised arch, a raised metatarsal dome, a raised heel dome, cushioned foot areas, and a raised outer border 187; and, (4) cushioned straps 247 and toe strap 248 to secure the sandal to a user's foot. Surrounding the a top (foot contact) surface of the sandal 100 is a raised outer border 287 that improves stability and support of the user's foot, and prevents slippage of the foot in the sandal 100, and an internal raised slope positioned between the top surface contact of the sandal and the raised edge 187.

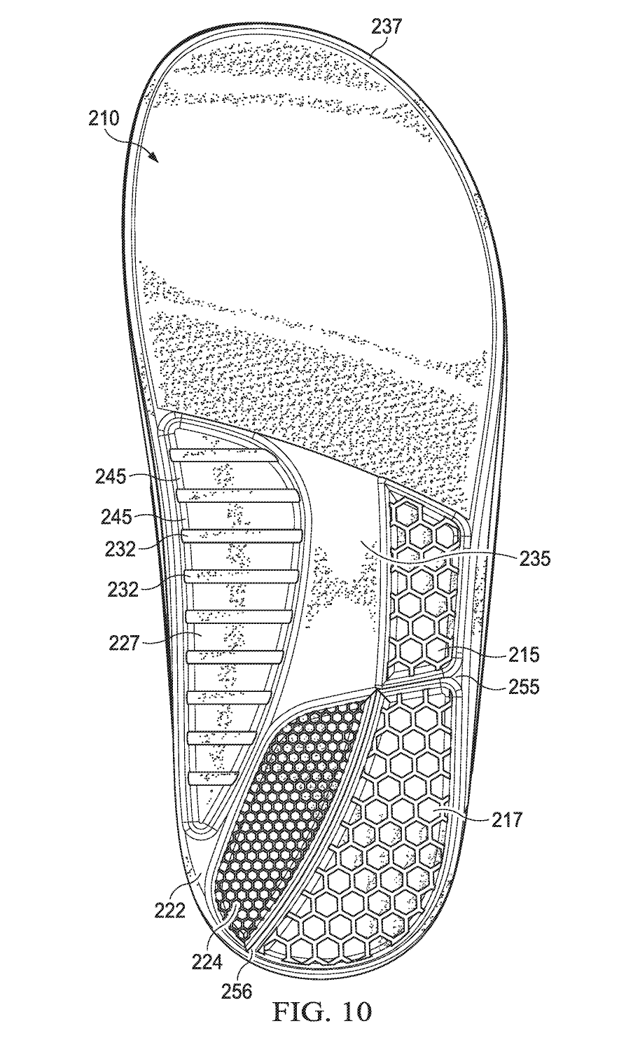

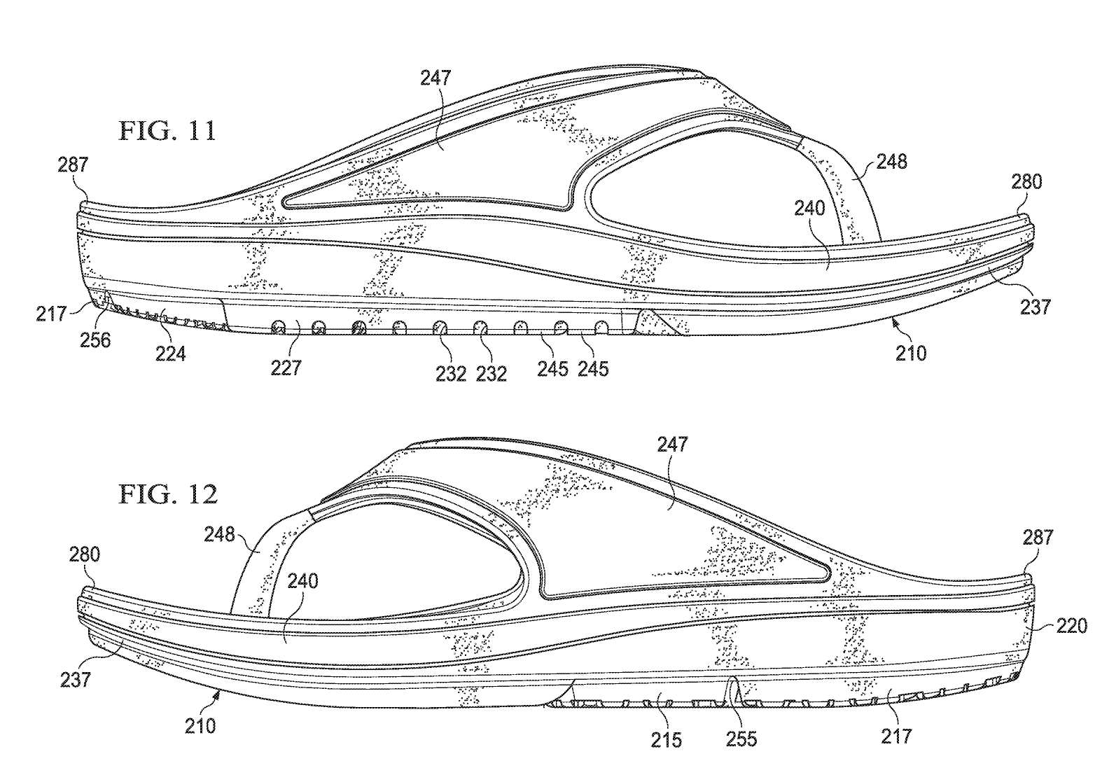

In FIGS. 9 and 10, a prospective bottom view and bottom view are shown of this alternative embodiment, and in FIGS. 11 and 12, side views of this alternative embodiment are shown. The base bottom surface 237 is defined on the bottom surface of the sandal 100 and is generally foot-shaped extending longitudinally from the from the toe end 280 to the heel end 220 and from the medial side to the lateral side of the sandal 200. The base bottom surface may have indentations dimensioned to receive pads or alternatively may have openings through the base bottom surface to receive pads that would secure to the middle layer.

The base bottom layer 237 supports the following functional features: a forefoot pad 210 having a flat surface, a stability arch compression pad 227, a lateral metatarsal pad 215, a lateral heel pad 217, a medial heel pad 224 (separated by a gap 256), and a metatarsal dome 235. The forefoot cushioning pad 210 has a flat surface extending longitudinally from the toe end 280 to the midfoot area adjacent the medial arch lateral midfoot area.

The stability arch compression pad 227 is located in the medial arch area of the bottom layer 237, and it has grooves 232 oriented in a direction transverse to the longitudinal length (toe to heel axis) of the sandal. Between the grooves 232 are raised flat compression pads 245 that generally extend laterally from the medial side of the arch area to the midfoot area. The grooves 232 and flat compression pads 245 occupy the stability arch compression pad 227, but these features all extend transverse to the longitudinal lengthwise (toe to heel) axis of the sandal from the medial arch area to the metatarsal area of the base layer 237.

The lateral metatarsal midfoot cushioning pad 215 is a trapezoidal shaped area extending generally from the distal edge of the heel area 220 to the proximal edge of the forefoot area on the lateral side of the sandal bottom layer 237 and encompassing the area approximately under a portion of the 4^{th} and 5^{th} metatarsal bones and a portion of the cuboid bone.

The lateral heel cushioning pad 21 and medial heel cushioning pad 224 are shown in FIGS. 9-11 in the heel area 220 of the sandal 100. The lateral heel cushioning pad 217 extends generally from the heel (calcaneal bone) area 280 forward to a portion of the cuboid bone on the lateral side of the sandal bottom 237 adjacent the lateral midfoot cushioning pad 215 and extends medially from the lateral side of the heel area to approximately the central portion of the heel area 280.

Gaps and separations 255 and 256 between the base components on the base bottom surface 237 also provide improved flexure zones for the cushioning and support components of the medial arch area, lateral midfoot area, forefoot area and heel area. Separation gap 255 is positioned between the lateral midfoot pad 215 and the lateral heel pad 217, and separation gap 256 is located between the lateral heel pad 217 and the medial heel pad 224.

An improved sandal has been disclosed. It ill be readily apparent that the illustrative embodiments of a sandal thus disclosed may be useful in cushioning the foot and controlling pronation dining activities such as hiking, backpacking, and the like. However, one will understand that the components of the sandal system may be modified to accommodate other activities or to control other kinds of foot motion. Thus, the description provided herein, including the presentation of specific thicknesses, materials, and properties of the sandal components, is provided for purposes of illustration only and not of limitation, and that the invention is limited only by the appended claims.

1. A contoured sandal having a top side that contacts the users foot, a lateral side that lies adjacent to the outer side of a user's foot in use and a medial side that lies adjacent the inner side, or arch, of a user's foot, said sandal comprising:
(i) a base bottom surface defined on the bottom surface of the sandal and is generally foot-shaped extending longitudinally from the toe end to the heel end and from the medial side to the lateral side of the sandal, said base bottom surface having:
(a) a forefoot pad having rolling ridges and gaps in the forefoot area, said rolling ridges are oriented in a direction transverse to the longitudinal axis of the sandal (lengthwise) and extend laterally across the sandal forefoot from the medial to the lateral side;
(b) a stability arch compression pad located in the medial arch area, said stability arch compression pad having grooves oriented in a direction transverse to the longitudinal length (toe to heel axis) of the sandal and raised flat compression pads located between said grooves that generally extend laterally from the medial side of the arch area to the midfoot area;
(c) a lateral metatarsal pad located in the lateral midfoot metatarsal area;
(d) a lateral heel pad located on the lateral side of the heel area;
(e) a medial heel pad located on the medial side of the heel area;
(f) a metatarsal dome located under the midfoot metatarsal area;
(ii) a top layer on the top side of the sandal having a contoured shape which receives and supports the foot of the user, a heel end, and a toe end, said top surface having:
(a) a raised arch in the medial arch area;
(b) a heel dome raised above the top layer and located over the heel area of the sandal;
(c) a metatarsal dome raised above the top layer and located over the metatarsal midfoot area of the sandal;
(iii) a bifurcated middle support layer having an upper support layer located adjacent to the top surface layer and a middle support layer located between the upper support layer and the bottom layer; and,
(iv) a top sheet that extends across the top layer from the heel end to the toe end of the sandal.

2. The sandal of claim 1, wherein the base bottom surface has indentations dimensioned to receive pads.

3. The sandal of claim 1, wherein the base bottom surface has openings through the base bottom surface to receive pads that would secure to the middle layer.

4. The sandal of claim 1, wherein the lateral heel pad and the medial heel pad both are separated by a gap.

5. The sandal of claim 1, wherein said base layer bottom surface is made of polyurethane polyester glycol with a hardness 10-30 Asker ±3.

6. The sandal of claim 1, wherein said heel pad is made of pre-blown EVA (ethylene-vinyl acetate) material.

7. The sandal of claim 6, wherein said heel pad has a hardness rating of 10-35 Asker ±3.

8. The sandal of claim 1, wherein said base bottom surface is made of a durable nylon fabric.

9. The sandal of claim 1, wherein said top sheet is made of 65% Nylon/35% polyester.

10. A contoured sandal having a top side that contacts the user's foot, a lateral side that lies adjacent to the outer side of a user's foot in use and a medial side that lies adjacent the inner side, or arch, of a user's foot, said sandal comprising:
(i) a base bottom surface defined on the bottom surface of the sandal and is generally foot-shaped extending longitudinally from the toe end to the heel end and from the medial side to the lateral side of the sandal, said base bottom surface having:
(a) a forefoot pad having rolling ridges and gaps in the forefoot area, said rolling ridges are oriented in a direction transverse to the longitudinal axis of the sandal (lengthwise) and extend laterally across the sandal forefoot from the medial to the lateral side;
(b) a stability arch compression pad located in the medial arch area, said stability arch compression pad having grooves oriented in a direction transverse to the longitudinal length (toe to heel axis) of the sandal and raised flat compression pads located between said grooves that generally extend laterally from the medial side of the arch area to the midfoot area;
(c) a lateral metatarsal pad located in the lateral midfoot metatarsal area;
(d) a lateral heel pad located on the lateral side of the heel area;
(e) a medial heel pad located on the medial side of the heel area;
(f) a metatarsal dome located under the midfoot metatarsal area;
(ii) a top layer on the top side of the sandal having a contoured shape which receives and supports the foot of the user, a heel end, and a toe end, said top surface having:
(a) a raised arch in the medial arch area;
(b) a heel dome raised above the top layer and located over the heel area of the sandal;
(c) a metatarsal dome raised above the top layer and located over the metatarsal midfoot area of the sandal; and,
(iii) a bifurcated middle support layer having an upper support layer located adjacent to the top surface layer and a middle support layer located between the upper support layer and the bottom layer.

11) The sandal of claim 10, wherein the upper support layer has a variable thickness that varies from toe end to heel end.

12) The sandal of claim 10, wherein the middle upper support layer has a variable thickness that varies from toe end to heel end.

13) The sandal of claim 10 further comprising:
a top sheet that extends across the top layer from the heel end to the toe end of the sandal.

14. The sandal of claim 13 wherein the base bottom surface has indentations dimensioned to receive pads.

15) The sandal of claim 10, wherein the base bottom surface has openings through the base bottom surface to receive pads that would secure to the middle layer.

16) The sandal of claim 10, wherein the lateral heel pad and the medial heel pad both are separated by a gap.

17) The sandal of claim 10, wherein said base layer bottom surface is made of polyurethane polyester glycol with a hardness 10-30 Asker ±3.

18) The sandal of claim 10, wherein said heel pad is made of pre-blown EVA (ethylene-vinyl acetate) material.

19) The sandal of claim 18, wherein said heel pad has a hardness rating of 10-35 Asker ±3.

20) The sandal of claim 10, wherein said base bottom surface is made of a durable nylon fabric.

21) The sandal of claim 10, wherein said top sheet is made of 65% Nylon/35% polyester.

22) A method of making a contoured sandal comprising the steps of:
(i) providing a base layer with a contoured shape which receives and supports the foot of the user, said base layer having a heel end, a toe end, a top surface, a bottom surface, a lateral side and a medial side, said lateral and medial sides extending approximately from said heel end to said toe end, and said base layer having:
(a) a forefoot pad having rolling ridges and gaps in the forefoot area, said rolling ridges are oriented in a direction transverse to the longitudinal axis of the sandal (lengthwise) and extend laterally across the sandal forefoot from the medial to the lateral side;
(b) a stability arch compression pad located in the medial arch area, said stability arch compression pad having grooves oriented in a direction transverse to the longitudinal length (toe to heel axis) of the sandal and raised flat compression pads located between said grooves that generally extend laterally from the medial side of the arch area to the midfoot area;
(c) a lateral metatarsal pad located in the lateral midfoot metatarsal area;
(d) a lateral heel pad located on the lateral side of the heel area;
(e) a medial heel pad located on the medial side of the heel area;
(f) a metatarsal dome located under the midfoot metatarsal area;
(ii) affixing a middle support layer to said base layer,
(iii) affixing a top layer to said middle layer, said top layer having a contoured shape which receives and supports the foot of the user, a heel end, and a toe end, said top surface having:
(a) a raised arch in the medial arch area;
(b) a heel dome raised above the top layer and located over the heel area of the sandal; and
(c) a metatarsal dome raised above the top layer and located over the metatarsal midfoot area of the sandal.

23. The method of making the sandal of claim 22, wherein said base layer is made of polyurethane polyester glycol with a hardness 10-30 Asker ±3.

24. The method of making the sandal of claim 22, wherein the middle support layer is a bifurcated middle support layer having an upper support layer located adjacent to the top surface layer and a middle support layer located between the upper support layer and the bottom layer.

25. The method of making the sandal of claim 24, wherein the upper support layer has a variable thickness that varies from toe end to heel end.

26. The method of making the sandal of claim 24, wherein the middle support layer has a variable thickness that varies from toe end to heel end.

27. The method of making the sandal of claim 22, wherein base layer is made of a durable nylon fabric.

28. The method of making the sandal of claim 22, wherein said top sheet is made of 65% Nylon/35% polyester.
